(19) United States
(12) Patent Application Publication
(10) Pub. No.: US 2015/0284994 A1
(43) Pub. Date: Oct. 8, 2015

(54) WINDOW INCLUDING HINGED SECURITY SCREEN

(71) Applicant: Larson Manufacturing Company of South Dakota, Inc., Brookings, SD (US)

(72) Inventors: Jordan Richter, Brookings, SD (US); Bruce Thomas, Brookings, SD (US)

(21) Appl. No.: 14/675,886

(22) Filed: Apr. 1, 2015

Related U.S. Application Data
(60) Provisional application No. 61/974,751, filed on Apr. 3, 2014.

(51) Int. Cl. E06B 9/52; E06B 9/02

(52) U.S. Cl. CPC E06B 9/52; E06B 9/02

(57) ABSTRACT

A security screen window assembly including a master frame having a first side and a second side, a first screen assembly attached to the first side of the master frame, and a second screen assembly positioned adjacent to the first screen assembly and adjacent to the first side of the master frame, wherein the second screen assembly is pivotably attached to the first screen assembly to provide for pivotable movement of a first member of the second screen assembly relative to the first screen assembly.

### PRIORITY

The present nonprovisional patent Application claims priority under 35 U.S.C. §119(e) from United States Provisional patent application having Ser. No. 61/974,751, filed on Apr. 3,2014, by Richter et al. and titled “WINDOW INCLUDING HINGED SECURITY SCREEN,” wherein the entirety of said provisional patent application is incorporated herein by reference.

### TECHNICAL FIELD

The present invention relates to security screens for windows and doors. More particularly, the invention relates to sturdy, rigid, and durable frames and screens that are capable of resisting damage from intruders, projectiles, and environmental stresses.

### BACKGROUND

Windows openings in buildings often include a combination of glass and screen panels that can be configured by the user to provide a desired environment within a room. For example, if it is desired to prevent outside air from entering a room, one or more glass panels can be moved to a closed position, and the glass panels can optionally be locked to each other or to a window frame. Alternatively, if it is desired to allow air to enter a room, the glass panels can be adjusted to expose one or more screens. In either of these cases, however, the only barrier provided to prevent an intruder from entering the room through the window opening are the glass and/or screen panels. For this reason, security features can be added to window openings that prevent an intruder from simply breaking the glass and/or cutting the screen to gain entry to the building.

One security feature that is commonly used is the addition of metal window bars to cover a window, which can be bolted or otherwise secured to the building and/or window frame structure. Although such window bars can be effective, the bars are considered aesthetically unpleasant in some situations, such as for residential buildings, as they can both detract from the exterior appeal of the building and obstruct the view from the interior to the exterior of the building. An alternate security feature that does not involve bars is the addition of security screens to a window opening, wherein such screens can be made of relatively rigid metal that is not easily cut or damaged by an intruder. The security screens can be made of stainless steel mesh, for example, which can be secured to a window frame with a number of screws or bolts that can detract from the appearance of the window. Both the security bars and security screens are often permanently mounted such that they do not allow for egress through the window opening in the case of an emergency. There is therefore a need to provide an aesthetically-pleasing window security screen system that provides protection from intruders while allowing emergency egress through the window opening. A flexible system offering the user the ability to choose combinations of protection from weather, intruders, insects, and to also enhance energy efficiency would offer further advantages.

### SUMMARY

In accordance with the invention, a security window system is provided that utilizes a stainless steel woven mesh for deterring intruders from gaining access to a building through a window opening. The system offers similar protection to window bars, but does not detract from the exterior appearance of the building or negatively impact the view from the interior of the building. The system also allows for egress in the case of an emergency. The system generally includes extruded pieces that are screwed together to make a master frame, such as an aluminum master frame. A hinged two-panel security screen is fastened to the exterior of the master frame. The mesh of the security screen is held within a top or bottom screen frame using a channeled extrusion that has been crimped and peened onto the screen. Slide bolts or other mechanism(s) are used to secure the bottom corners of the hinged panel in a closed or locked position. Two glass sashes are fitted to the master frame, and these glass sashes are slideable relative to each other to expose one or both of the screens, as desired. The screens can allow for ventilation and also improve the energy efficiency of the building. An optional insect screen can also be positioned adjacent to the stainless steel mesh panels.

### BRIEF DESCRIPTION OF THE DRAWINGS

The present invention will be further explained with reference to the appended Figures, wherein like structure is referred to by like numerals throughout the several views, and wherein:

FIG. 1 is a front view of a security screen window assembly, in accordance with the present invention;

FIG. 2 is a cross-sectional side view of the security screen window assembly of FIG. 1 taken along section line A-A;

FIG. 3 is an enlarged a cross-sectional side view of a top portion of the security screen window assembly of FIGS. 1 and 2;

FIG. 4 is an enlarged a cross-sectional side view of a middle portion of the security screen window assembly of FIGS. 1 and 2;

FIG. 5 is an enlarged a cross-sectional side view of a bottom portion of the security screen window assembly of FIGS. 1 and 2;

FIG. 6 is an exploded perspective view of a security screen window assembly of the invention;

FIG. 7 is an exploded perspective view of the master frame of the security screen window assembly of FIG. 6;

FIG. 8 is an exploded perspective view of the top screen assembly of the security window assembly of FIG. 6;

FIG. 9 is an exploded perspective view of the bottom screen assembly of the security window assembly of FIG. 6;

FIG. 10 is a side view of a window frame of the invention, with a security screen positioned relative to a crimping portion in an open configuration;

FIG. 11 is a side view of a window frame of the invention, with a security screen positioned relative to a crimping portion in a closed configuration and with an insect screen in place; and

FIG. 12 is a perspective view of an exemplary configuration of a security screen window assembly of the invention with a bottom screen assembly in an open position.

### DETAILED DESCRIPTION

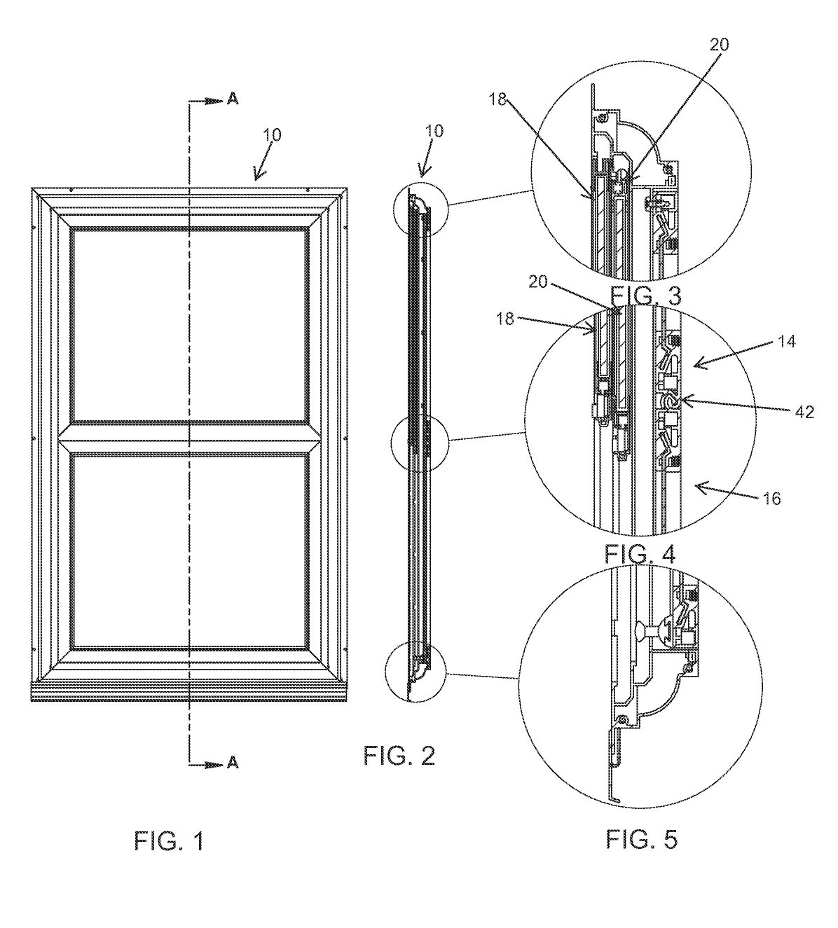

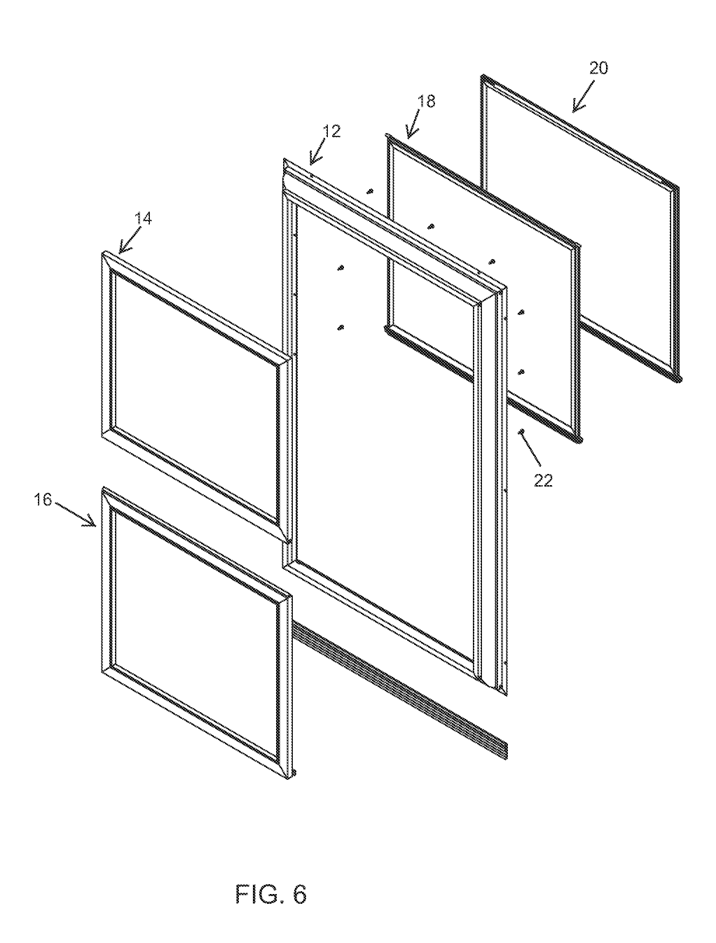

Referring now to the Figures, wherein the components are labeled with like numerals throughout the several Figures, and initially to FIGS. 1-6, an embodiment of a security screen window assembly 10 is illustrated, which includes a master frame 12, a top screen assembly 14, a bottom screen assembly 16, a top glass panel 18, and a bottom glass panel 20. In general, the system is assembled by attaching the top screen assembly 14 to the master frame 12, such as with a plurality of screws 22, to provide for a rigid attachment between these components. The bottom screen assembly 16 is attached to the top screen assembly 14 at a hinged connection so that the bottom screen assembly 16 can be swung outwardly to allow for egress, as will be discussed in further detail below. The top and bottom glass panels 18, 20 can be vertically slid relative to each other and relative to the master frame 12 to allow for ventilation, wherein the glass panels 18, 20 can each move independently relative to the other glass panel in separate tracks. When the glass panels 18, 20 are located in their closed positions, a locking mechanism (not shown) can be engaged to lock the panels relative to each other within the master frame 12. The entire security screen window assembly 10 can be mounted to or over a window using security fasteners (e.g., tamper-resistant screws) that are designed to be permanent or semi-permanently installed in that they are not easily removable using standard tools after they have been installed.

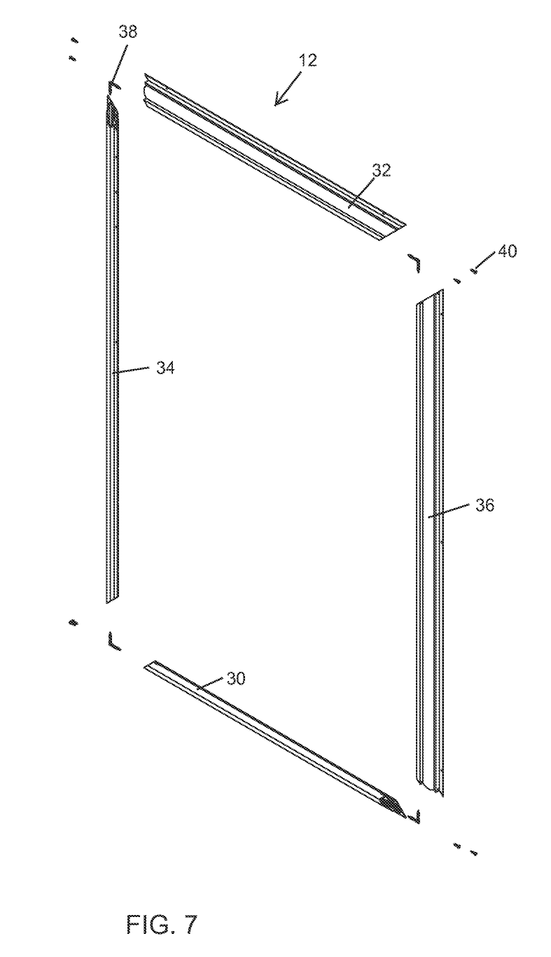

An exploded view of an embodiment of the master frame 12 is illustrated in FIG. 7. As shown, master frame 12 includes a sill 30, a header 32 that will be generally parallel to sill 30 when the frame 12 is assembled, a left jamb 34 extending between sill 30 and header 32, and a right jamb 36 that is spaced from and generally parallel to the left stile 34, and that extends between sill 30 and header 32. Each of these four structural members includes mitered ends cut at an angle of approximately 45 degrees. These four structural members are connected to each other via four corner key members 38, each of which is located at one of the four corners and are provided to ensure that the miters align on the exterior surface of the master frame 12. Master frame 12 further includes one or more fasteners 40 (e.g., screws) to correspond with each of the four corners when the frame is assembled. Both the sill 30 and the header 32 include screw bosses for receiving the fasteners 40 during assembly of the master frame 12. The sill 30, header 32, and left and right jambs 34, 36 can be made of extruded aluminum or another relatively rigid material that is resistant to damage by impact, vandalism, and/or environmental factors.

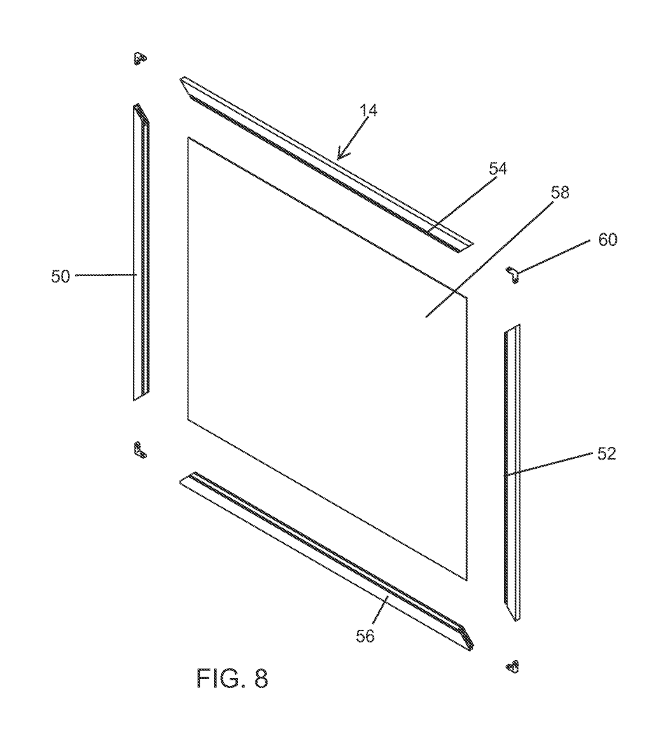

An exploded view of an embodiment of the top screen assembly 14 is illustrated in FIG. 8. As shown, top screen assembly 14 includes a frame that consists of four structural members, including a left side member 50, an opposite right side member 52, a top member 54, and a bottom member 56. Each of these structural members includes an elongated linear portion with ends that are angled (e.g., 45 degrees) for forming mitered corners when the frame is assembled. The assembly 14 further includes a security screen panel 58 that is sized and shaped for engagement with the four structural members 50, 52, 54, and 56. In one exemplary assembly procedure, three of the structural members (e.g., 50, 52, and 54) are assembled with the use of a corner key 60 at each corner, which are used to ensure that the structural members are perpendicular to each other at the four corners. Each corner key 60 is configured as an L-shaped member, and may be made of metal, plastic, or another material that can maintain a generally 90 degree angle when engaged with the structural members of the top screen assembly 14.

At this point, the assembly will consist of a U-shaped frame. The security screen panel 58 can then be slid into the opening of the U-shaped frame, and then the fourth structural member (e.g., member 56) can be positioned relative to the other structural members and held square with the help of two additional corner keys 60. The four structural members are provided with profiles that allow for secure engagement with the security screen panel, wherein a number of different profiles are contemplated by the invention.

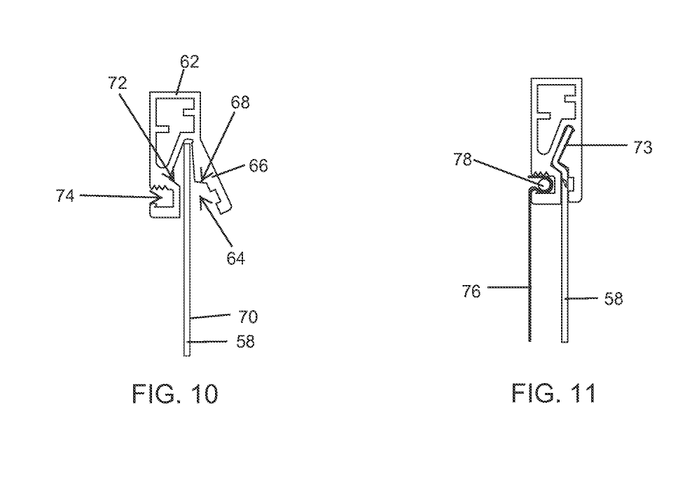

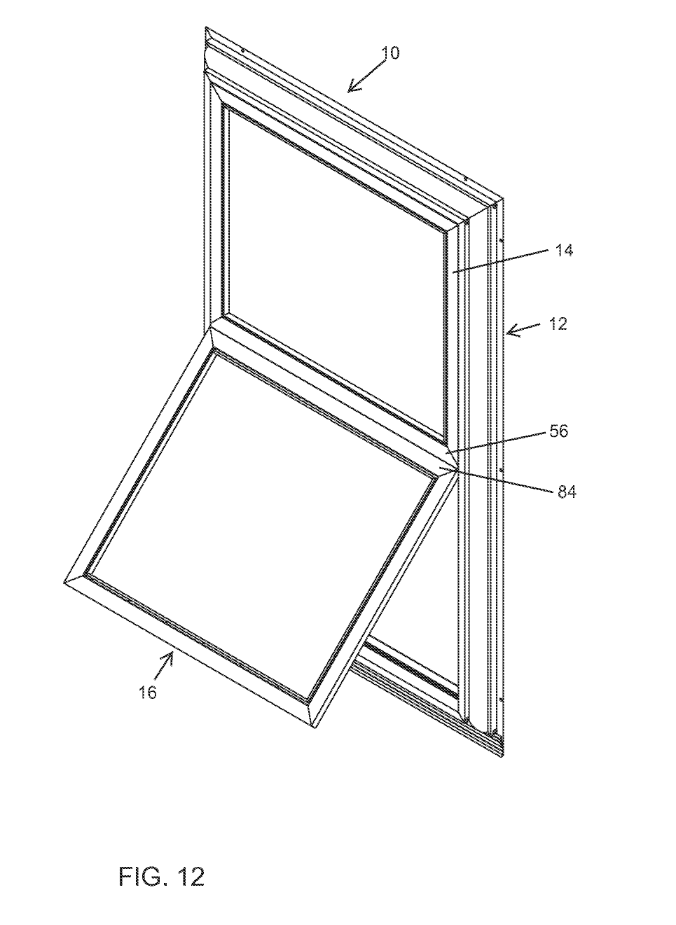

One exemplary profile of at least one of the structural members of the top screen assembly 14 is illustrated in an open position in FIG. 10, which includes a base extrusion 62 having a first opening 64 in which an edge of the screen panel 58 can be inserted. When an edge of the screen panel 58 is properly positioned within this opening 64, a moveable leg 66 is pivoted or moved toward the base extrusion 62 until its contoured surface 68 contacts a first side 70 of the screen panel 58. The leg 66 is then pressed toward the base extrusion 62, which includes a shaped surface 72 that corresponds generally to the shape of the surface 68. Enough force is used when pressing these two surfaces toward each other to deform or crimp the screen panel 58 within a predefined channel 73 between the leg 66 and base extrusion 62, as shown in FIG. 11. This channel 73 is shown as providing two bends adjacent to the end of the screen panel 58, although it is understood that the channel 73 can instead be configured with a different number and shape of contours and/or bends, wherein the embodiment of FIG. 11 illustrates just one exemplary channel 73 that for securely attaching to the screen panel 58. The process of crimping an edge of the screen panel 58 within each structural member is repeated for all four members of the screen assembly 14.

The crimping process increases the security of the screen assembly by providing a resistive force against removal of the screen from the four structural members, and also serves to generate tension in the screen panel to keep it taut and rigid within the screen assembly. An additional process to further secure the screen panel 58 within the structural members may be utilized. For example, once the screen panel has been crimped between surfaces 68 and 72 of the four structural members, material from the bottom of groove 74 may be formed or displaced into, and engaged with, the woven screen mesh of the screen panel. Punching, piercing, lancing, or peening are all possible methods for accomplishing this.

The base extrusion 62 can further include a second opening or groove 74 that is sized and shaped to accept the edge of an optional insect screen 76. Groove 74 includes its own configuration of contours and/or protrusions to provide for secure engagement with an edge of the insect screen 76, wherein one exemplary configuration is illustrated in FIGS. 10 and 11. In the illustrated configuration, the insect screen 76 can be positioned adjacent to the groove 74 and then a screen spline 78 can be pressed toward and inserted into the groove 74 while pressing the edge of the insect screen 76 into the groove 74. In this way, the insect screen 76 will be spaced from the screen panel 58 and secured within the top screen assembly 14. Once the insect screen 76 has been secured in groove 74 of structural members 50, 52, 54, and 56, any screen cloth extending beyond screen spline 78 may be trimmed off. Typically, the insect screen 76 is has a finer mesh structure than that of the screen panel 58 in order to block the entry of relatively small insects and particles.

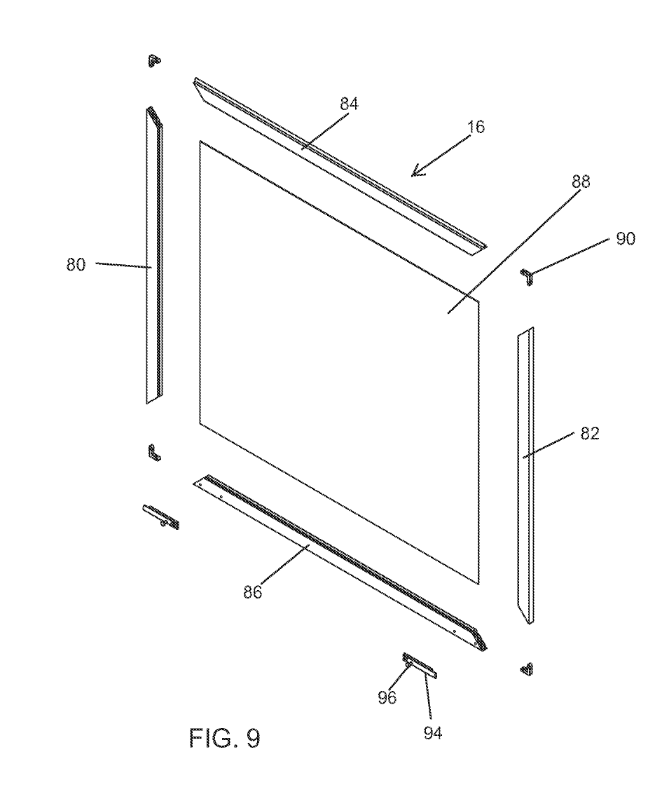

An exploded view of an embodiment of the bottom screen assembly 16 is illustrated in FIG. 9. Similar to top screen assembly 14, bottom screen assembly 16 also includes a frame that consists of four structural members, including a left side member 80, an opposite right side member 82, a top member 84, and a bottom member 86. Each of these structural members includes an elongated linear portion with ends that are angled (e.g., 45 degrees) for forming mitered corners when the frame is assembled. The assembly 16 further includes a security screen panel 88 that is sized and shaped for engagement with the four structural members 80, 82, 84, and 86. In one exemplary assembly procedure, three of the structural members (e.g., 80, 82, and 84) are assembled with the use of a corner key 90 at each corner, each of which is used to ensure that two adjacent structural members are perpendicular to each other where they meet at a corner. At this point, the assembly will consist of a U-shaped frame. The security screen panel 88 can then be slid into the opening of the U-shaped frame, and then the fourth structural member (e.g., member 86) can be positioned relative to the other structural members and held square with the help of another corner key 90. The four structural members are provided with profiles that allow for secure engagement with the security screen panel, wherein a number of different profiles are contemplated by the invention. One exemplary profile is that shown and described above relative to FIGS. 10 and 11. Similar to top screen assembly 14, bottom screen assembly 16 may be configured to receive an insect screen.

As set out above, the bottom screen assembly 16 will be capable of pivoting about a hinge relative to the top screen assembly 14 in order to provide egress from a building through its corresponding window opening, wherein an exemplary open position of the bottom screen assembly 16 is illustrated in FIG. 12. In particular, the bottom member 56 of top screen assembly 14 includes a hinge profile that is designed for slideable engagement with a corresponding hinge profile of the top member 84 of bottom screen assembly 16 to create a hinged connection 42, wherein a detail of an exemplary embodiment of such a hinged connection is best illustrated in the exploded cross-sectional view of FIG. 4. This hinged connection 42 allows an outward pivoting motion of the bottom screen assembly 16 relative to the top screen assembly 14, such as to provide egress from the window opening.

The bottom screen assembly 16 may further be provided with one or more slide bolts 94, which are shown in both FIG. 5 and FIG. 9. In a closed or locked position, the ends of slide bolts 94 are engaged with master frame 12 to prevent outward pivoting of bottom screen assembly 16 with respect to top screen assembly 14. In accordance with this embodiment, slide bolts 94 are each provided with an extending knob 96 that can be grasped by a user to move the bolts 94 horizontally relative to the bottom member 86 to release that edge of the bottom screen assembly 16 from the master frame 12. In one embodiment, releasing the bottom member 86 from the master frame 12 includes the step of translating the slide bolts 94 toward each other along the bottom member 86 until that edge is unlocked or free to move relative to the master frame 12. Different or additional devices or constructions may be used to keep the bottom screen assembly 16 in a closed or locked configuration until it is desired to allow it to pivot outwardly, wherein such devices or constructions may be associated with the bottom member 86 and/or another of the members 80, 82, or 84, or master frame 12.

Referring again to FIGS. 3-5, enlarged views of portions of the security screen window assembly 10 illustrate exemplary relationships of the various panels relative to each other. For example, as can best be seen in FIGS. 3 and 4, the two glass panels 18, 20 have separate tracks in which they can slide to expose and cover the opening within the master frame 12, as desired. The frame structure also provides for at least a small gap or space between the outermost window and an adjacent security screen. The glass panels 18, 20 can optionally be provided with rollers or other features that provide for easier movement of the panels within their respective tracks.

The screen material used as the security screen for one or both of the top screen assembly 14 and the bottom screen assembly 16 can be stainless steel or another material that provides a desired amount of strength and rigidity, while also being relatively resistant to environmental factors, such as corrosion. The material from which the security screen is made can include wires that have a greater thickness or strength than that of typical insect screens in order to provide for better resistance to intruders. In addition, the screen material can have a grid pattern that is at least somewhat more open than that of a traditional insect screen in order to accommodate the thicker wires while still providing enough open space for viewing and/or air movement through the screen, although it is also contemplated that the grid pattern can be less open than that of a traditional insect screen.

Further, it is understood that the cross-sectional shape of each of the four structural members of each of the top and bottom screen assemblies may be the same or different from each other, which is also true with regard to the structural members of the master frame. The method of assembling the master frame 12 and/or the top and bottom screen assemblies can be different than described without affecting the function of the window, which is also true with regard to the glass inserts. That is, the structural members of any of the frames described herein can be secured using screws or other fasteners instead of crimping the components together, as described above. Additionally, an embodiment comprising a single screen assembly pivotably secured to the master frame, instead of two cooperating screen assemblies as described herein, is contemplated.

While the embodiments discussed above have primarily been described in the context of enhancing a window opening, the invention may also be used to enhance other building openings such as windows in doors. In addition, it is contemplated that screen panels and glass panels may be interchanged with each other relative to the described embodiments to provide for window assemblies that are arranged in different configurations than those described above. Further, although the described embodiments refer to the security screens as being “top” and “bottom” screen assemblies, it is contemplated that a pivoting security screen may instead be positioned above or next to a stationary screen.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described herein.

What is claimed is:

1. A security screen window assembly comprising:
a master frame comprising a first side and a second side;
a first screen assembly attached to the first side of the master frame; and
a second screen assembly positioned adjacent to the first screen assembly and adjacent to the first side of the master frame, wherein the second screen assembly is pivotably attached to the first screen assembly to provide for pivotable movement of a first member of the second screen assembly relative to the first screen assembly.

2. The security screen window assembly of claim 1, further comprising:
a first glass panel slideably moveable within a first track of the master frame; and
a second glass panel slideably moveable within a second track of the master frame;
wherein at least one of the first and second glass panels is moveable so that the first member of the second screen assembly is accessible from the second side of the master frame.

3. The security screen window assembly of claim 1, wherein the first screen assembly comprises a top screen assembly, and wherein the second screen assembly comprises a bottom screen assembly positioned adjacent to and below the top screen assembly.

4. The security screen window assembly of claim 1, wherein at least one of the first and second screen assemblies comprises a security screen mounted within a first or second screen frame, respectively.

5. The security screen window assembly of claim 4, wherein at least one of the first and second screen assemblies further comprises an insect screen spaced from the security screen.

6. The security screen window assembly of claim 4, wherein the security screen comprises multiple screen frame members, wherein at least one of the screen frame members comprises an extrusion that comprises a channel configured for engagement with screen material adjacent to an edge of the security screen.

7. The security screen window assembly of claim 6, wherein the channel comprises at least one contour.

8. The security screen window assembly of claim 6, wherein the extrusion further comprises a leg that is moveable toward a base portion to form the channel.

9. The security screen window assembly of claim 6, wherein the screen material adjacent to one of the edges of the security screen is crimped within the channel.

10. The security screen window assembly of claim 1, wherein the second screen assembly comprises at least one securing mechanism that is engageable with the master frame to allow for selective pivoting of the second screen assembly relative to the first screen assembly.

11. The security screen window assembly of claim 10, wherein the at least one securing mechanism comprises a slide bolt that is slideable relative to a second member of the second screen assembly.

12. A security screen window assembly comprising:
a master frame comprising a first side, a second side, and a central frame opening; and
a screen assembly comprising a first position in which the screen assembly at least partially covers the central frame opening, wherein the screen assembly is pivotably attached to the master frame to provide for pivotable movement of the screen assembly relative to the master frame to a second position in which at least a portion of the central frame opening is uncovered.

13. A security screen assembly comprising multiple screen frame members, wherein security screen material is mounted within at least one of the multiple frame members, and wherein at least one of the screen frame members comprises an extrusion that comprises a first channel formed by a leg that is moveable toward a base portion to form a channel that is configured for engagement with the security screen material adjacent to its edge.

14. The security screen assembly of claim 13, wherein the extrusion comprises a second channel spaced from the first channel, wherein the second channel is engageable with an insect screen material that is spaced from the security screen material.

15. The security screen assembly of claim 14, further comprising a screen spline pressed into the second channel for securing the insect screen within the second channel.
